(19) United States
(12) Patent Application Publication
(10) Pub. No.: US 2026/0089477 A1
(43) Pub. Date: Mar. 26, 2026

(54) SYSTEMS AND METHODS FOR MULTIMODAL EMERGENCY MANAGEMENT OF SMART CITIES BASED ON LARGE MODELS OF INTERNET OF THINGS

(71) Applicant: CHENGDU QINCHUAN IOT TECHNOLOGY CO., LTD., Chengdu (CN)

(72) Inventor: Hanshu SHAO, Chengdu (CN)

(73) Assignee: CHENGDU QINCHUAN IOT TECHNOLOGY CO., LTD., Chengdu (CN)

(21) Appl. No.: 19/408,304

(22) Filed: Dec. 3, 2025

(30) Foreign Application Priority Data
Oct. 22, 2025 (CN) 202511508315.1

(51) Int. Cl. H04W 4/90; G06N 20/00; G06Q 10/0631; H04L 67/1029

(52) U.S. Cl. CPC H04W 4/90; G06N 20/00; G06Q 10/06315; H04L 67/1029

(57) ABSTRACT

A system and a method for multimodal emergency management of a smart city based on a large model of internet of things are provided. The method is executed by an emergency supervision management platform. The method includes: based on a preset cycle, for each of a plurality of sub-data centers, determining a second target dataset and a target processing order based on a remaining computing resource, a reference computing resource, and a first target dataset; predicting a pending data volume based on first historical data; based on the reference computing resource and the pending data volume, predicting a resource occupancy condition, and generating an overload condition; determining a data transmission order based on the target processing orders of the plurality of sub-data centers, and transmitting the second target dataset based on the data transmission order.

### CROSS-REFERENCE TO RELATED APPLICATIONS

This application claims priority to Chinese Patent Application No. 202511508315.1, filed on Oct. 22, 2025, the entire contents of which are hereby incorporated by reference.

### TECHNICAL FIELD

The present disclosure relates to the field of emergency management technology, and in particular, relates to systems and methods for multimodal emergency management of smart cities based on large models of Internet of Things (IoT).

### BACKGROUND

Urban emergency management integrates various urban emergency service resources to provide citizens with emergency rescue services and ensure public safety in a city. Currently, existing technologies for multimodal emergency management data processing face issues such as unbalanced resource allocation, low timeliness of collaboration among different platforms, and the inability to obtain data volumes for future multimodal emergency management data.

Therefore, it is necessary to provide a system and a method for multimodal emergency management of a smart city based on a large model of Internet of Things, so as to process data in a timely and effective manner, obtain the data volume of emergency management data at future time points, and ensure the stable operation of urban emergency management.

### SUMMARY

One or more embodiments of the present disclosure provide a system for multimodal emergency management of a smart city based on a large model of Internet of Things (IoT). The system includes: an emergency supervision management platform, an emergency supervision sensor network platform, and an emergency supervision object platform; wherein the emergency supervision management platform includes an emergency supervision central platform, a plurality of emergency supervision sub-platforms, and a plurality of sub-data centers. the emergency supervision management platform is configured to: based on a preset cycle, for each of the plurality of sub-data centers, determine a second target dataset and a target processing order based on a remaining computing resource, a reference computing resource, and a first target dataset; predict a pending data volume based on first historical data; based on the reference computing resource and the pending data volume, predict a resource occupancy condition, and generate an overload condition; determine a data transmission order for each of the plurality of sub-data centers based on target processing orders of the plurality of sub-data centers, and transmit the second target dataset of each of the plurality of sub-data centers based on the data transmission order of the sub-data center.

One or more embodiments of the present disclosure provide a method for multimodal emergency management of a smart city based on a large model of Internet of Things (IoT), executed by an emergency supervision management platform. The method includes: based on a preset cycle, for each of a plurality of sub-data centers, determining a second target dataset and a target processing order based on a remaining computing resource, a reference computing resource, and a first target dataset; predicting a pending data volume based on first historical data; based on the reference computing resource and the pending data volume, predicting a resource occupancy condition, and generating an overload condition; determining a data transmission order for each of the plurality of sub-data centers based on target processing orders of the plurality of sub-data centers, and transmitting the second target dataset of each of the plurality of sub-data centers based on the data transmission order of the sub-data center.

One or more embodiments of the present disclosure provide a non-transitory computer-readable storage medium, storing computer instructions, wherein when a computer reads the computer instructions from the storage medium, the computer executes the method for multimodal emergency management of a smart city based on a large model of Internet of Things (IoT).

Some embodiments of the present disclosure include at least the following beneficial effects. (1) By utilizing a trained trend prediction model, the disaster development trend corresponding to the target processing order can be accurately predicted. Based on the disaster development trend, a rescue vehicle type and a rescue vehicle count are determined, thereby generating a rescue vehicle control instruction to dispatch the corresponding types and counts of rescue vehicles for emergency response, ensuring rescue efficiency while minimizing the consumption of manpower and material resources to the greatest extent possible. (2) By obtaining road condition data during a process in which the rescue vehicle travels based on the rescue route, a risk region can be determined and transmitted to the emergency supervision management platform. This enables the emergency supervision management platform to more accurately understand the actual risk situation, thereby enhancing the targeted response and timeliness of rescue operations.

### BRIEF DESCRIPTION OF THE DRAWINGS

The present disclosure will be further illustrated by way of exemplary embodiments, which will be described in detail through the accompanying drawings. These embodiments are not limiting, and in these embodiments, the same numbering denotes the same structure, wherein:

FIG. 1 is a schematic diagram illustrating an exemplary system for multimodal emergency management of a smart city based on a large model of IoT according to some embodiments of the present disclosure;

FIG. 2 is a flowchart illustrating an exemplary process for multimodal emergency management of a smart city based on a large model of IoT according to some embodiments of the present disclosure;

FIG. 3 is a flowchart illustrating an exemplary process for generating a rescue vehicle control instruction according to some embodiments of the present disclosure; and

FIG. 4 is a schematic diagram illustrating an exemplary trend prediction model according to some embodiments of the present disclosure.

### DETAILED DESCRIPTION

In the following detailed description, numerous specific details are set forth by way of examples in order to provide a thorough understanding of the relevant disclosure. Obviously, drawings described below are only some examples or embodiments of the present disclosure. Those skilled in the art, without further creative efforts, may apply the present disclosure to other similar scenarios according to these drawings. It should be understood that the purposes of these illustrated embodiments are only provided to those skilled in the art to practice the application, and not intended to limit the scope of the present disclosure. Unless obviously obtained from the context or the context illustrates otherwise, the same numeral in the drawings refers to the same structure or operation.

It should be understood that “system,” “device,” “unit,” and/or “module” as used herein is a way to distinguish between different components, elements, parts, sections, or assemblies at different levels. However, these words may be replaced by other expressions if they accomplish the same purpose. The term “and/or”, as used in the claims and the specification, is merely a way of describing the associative relationship of an associated object, indicating that three relationships can exist, e.g., A and/or B, which may be represented as: An alone, both A and B, and B alone.

As indicated in the present disclosure and in the claims, the singular forms “a,” “an,” and “the” may be intended to include the plural forms as well, unless the context clearly indicates otherwise. In general, the terms “comprise,” “comprises,” and/or “comprising,” “include,” “includes,” and/or “including,” when used in this disclosure, specify the presence of stated features, integers, steps, operations, elements, and/or components, but do not preclude the presence or addition of one or more other features, integers, steps, operations, elements, components, and/or groups thereof.

Flowcharts are used in the present disclosure to illustrate the operations performed by the system according to some embodiments of the present disclosure. It should be understood that the operations described herein are not necessarily executed in a specific order. Instead, they may be executed in reverse order or simultaneously. Additionally, one or more other operations may be added to these processes, or one or more operations may be removed.

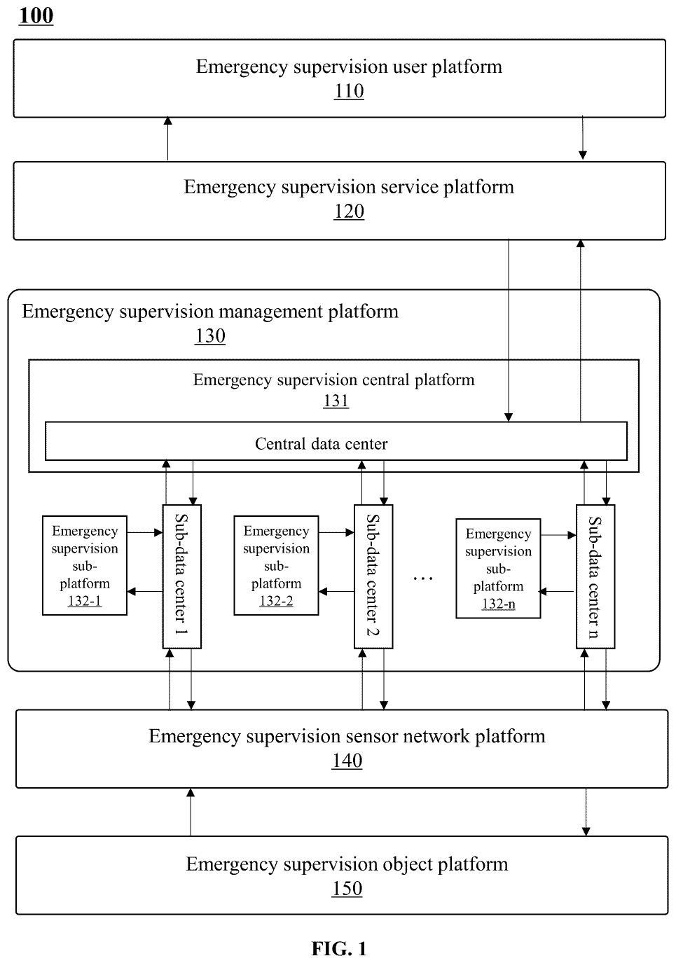

FIG. 1 is a schematic diagram illustrating an exemplary system for multimodal emergency management of a smart city based on a large model of IoT according to some embodiments of the present disclosure.

A system (hereinafter referred to as an emergency management system) for multimodal emergency management of a smart city based on a large model of IoT is provided according to some embodiments of the present disclosure. As shown in FIG. 1, an emergency management system 100 includes an emergency supervision user platform 110, an emergency supervision service platform 120, an emergency supervision management platform 130, an emergency supervision sensor network platform 140, and an emergency supervision object platform 150.

The large model of IoT (also referred to as an IoT large model) refers to a model capable of performing functions such as data processing and multimodal interaction. In some embodiments, via the IoT large model, the emergency management system 100 may implement a method for multimodal emergency management of a city provided according to some embodiments of the present disclosure.

The emergency supervision user platform 110 refers to a platform for interacting with a user. In some embodiments, emergency supervision user platform 110 may be configured as a terminal device.

In some embodiments, the emergency supervision user platform 110 may transmit a query instruction for emergency management data to the emergency supervision management platform 130 via the emergency supervision service platform 120, and receive data and/or information uploaded by the emergency supervision service platform 120.

The emergency supervision service platform 120 refers to a platform for receiving and transmitting data and/or information. In some embodiments, the emergency supervision service platform 120 may receive the query instruction issued by the emergency supervision user platform 110 and transmit the query instruction to the emergency supervision management platform 130.

The emergency supervision management platform 130 refers to a platform that coordinates and manages the connections and collaboration among functional platforms, aggregates all information within the emergency management system 100, and provides perception management and control management functions for the emergency management system 100.

In some embodiments, as shown in FIG. 1, the emergency supervision management platform 130 includes an emergency supervision central platform 131, a plurality of emergency supervision sub-platforms (e.g., an emergency supervision sub-platform 132-1, an emergency supervision sub-platform 132-2, . . . , an emergency supervision sub-platform 132-n as shown in FIG. 1), and a plurality of sub-data centers (e.g., a sub-data center 1, a sub-data center 2, . . . , a sub-data center n as shown in FIG. 1). The emergency supervision central platform 131 includes a central data center.

The emergency supervision central platform 131 refers to a platform that integrates all data and/or information and performs data analysis.

The central data center may aggregate and store all emergency management data of the emergency management system 100. In some embodiments, the central data center may transmit data to each of the plurality of sub-data centers and receive relevant data uploaded by each of the plurality of sub-data centers.

The emergency supervision sub platform refers to a platform that may integrate partial information and perform data analysis. In some embodiments, the emergency supervision management platform 130 includes a plurality of emergency supervision sub-platforms. Each of the plurality of emergency supervision sub-platforms corresponding to one of the plurality of sub-data centers. In some embodiments, each of the plurality of emergency supervision sub-platforms may exchange information with its corresponding sub-data center.

The sub-data center may aggregate and store a portion of the emergency management data of the emergency management system 100. In some embodiments, the sub-data center may exchange information with the central data center of the emergency supervision central platform 131, the corresponding emergency supervision sub-platform, and the emergency supervision sensor network platform 140. For example, the sub-data center may upload data (e.g., the emergency management data) monitored in real time by the emergency supervision object platform 150 and transmitted the data via the emergency supervision sensor network platform 140 to the central data center. As another example, the sub-data center may transmit emergency management data to the corresponding emergency supervision sub-platform and obtain processing results of the emergency management data from the corresponding emergency supervision sub-platform.

The emergency supervision sensor network platform 140 refers to a functional platform for managing sensor communication. In some embodiments, the emergency supervision sensor network platform 140 may be configured as a communication network and gateway to perform functions such as network management, protocol management, instruction management, and data parsing. In some embodiments, the emergency supervision sensor network platform 140 may receive data (e.g., the emergency management data) monitored in real time by the emergency supervision object platform 150 and upload the data to the emergency supervision management platform 130.

The emergency supervision object platform 150 refers to a functional platform for perceptual information generation and control information execution. For example, the emergency supervision object platform 150 may include a smart gas valve, a mobile emergency power vehicle, a display terminal disposed on a rescue vehicle, or the like. In some embodiments, the emergency supervision object platform 150 may obtain the emergency management data through a plurality of types of sensing devices (e.g., an image sensor, a sound sensor, and a camera) and upload the emergency management data to each of the plurality of sub-data centers via the emergency supervision sensor network platform 140. In some embodiments, the emergency supervision object platform 150 may obtain road condition data in real time and identify a risk region. In some embodiments, in response to receiving at least one of a valve control instruction, a power vehicle control instruction, and a rescue vehicle control instruction sent by the emergency supervision management platform 130 (e.g., the emergency supervision central platform 131), the emergency supervision object platform 150 may control the smart gas valve to automatically open or close based on an open-close state, control the mobile emergency power vehicle to travel based on a driving route and supply power based on a power output, and/or control the display terminal disposed on the rescue vehicle to display a rescue route based on a rescue arrival deadline.

More descriptions regarding the emergency management system may be found later in the present disclosure.

In some embodiments of the present disclosure, based on emergency management system, communication connection can be realized between various functional platforms, and a closed loop of information operation among the functional platforms can be formed. The emergency management system can run in a coordinated and regular manner under the unified management of the emergency supervision management platform, realizing smart and information-based of emergency management.

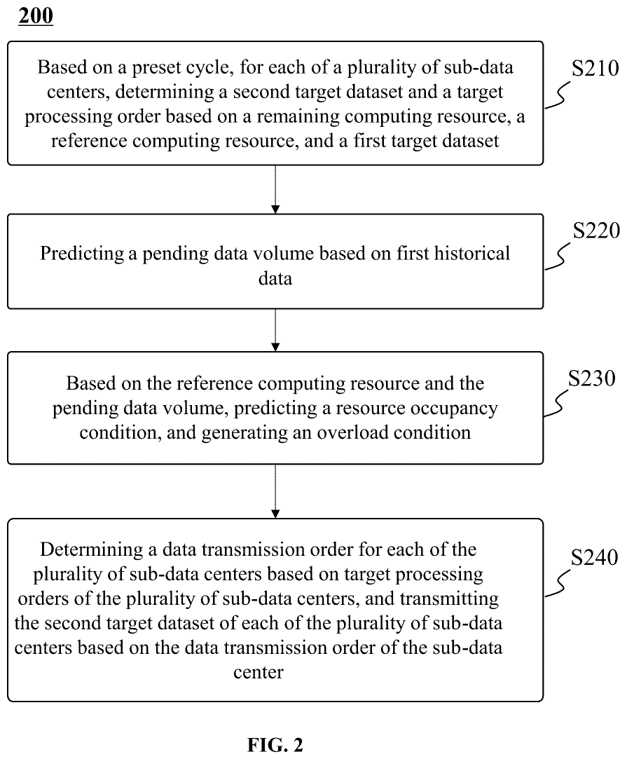

FIG. 2 is a flowchart illustrating an exemplary process for multimodal emergency management of a smart city based on a large model of IoT according to some embodiments of the present disclosure. As shown in FIG. 2, process 200 includes operation 210 to operation 240 as follows. In some embodiments, process 200 is executed by an emergency supervision management platform (e.g., an emergency supervision central platform).

In 210, based on a preset cycle, for each of a plurality of sub-data centers, a second target dataset and a target processing order may be determined based on a remaining computing resource, a reference computing resource, and a first target dataset.

In some embodiments, the preset cycle may be set by technical personnel based on experience.

The first target dataset refers to a dataset of all emergency management data to be processed by the sub-data center. In some embodiments, the first target dataset includes a plurality of emergency management data of different modalities to be processed.

The emergency management data refers to data related to emergency management. For example, the emergency management data may include an ambient temperature, a combustible gas concentration, a crowd size, a count of flammable and explosive substances, a fire intensity, or the like. The modality of the emergency management data refers to a data type of the emergency management data. Exemplary modalities of the emergency management data may include images, videos, audio, text, or the like.

In some embodiments, the emergency supervision object platform may obtain the emergency management data through various types of sensing devices (e.g., an image sensor, a sound sensor, and a camera) and upload the emergency management data to each of the plurality of sub-data centers via the emergency supervision sensor network platform.

It should be noted that each emergency management data may be transmitted with an electronic tag, which includes the modality of the emergency management data and a geographical region of the emergency management data. The geographical region of emergency management data refers to a geographical location of the sensing device collecting the emergency management data.

The remaining computing resource refers to an available computing resource remaining in the sub-data center. In some embodiments, the sub-data center may monitor and determine its resource occupancy condition in real time, thereby determining the remaining computing resource and transmitting the remaining computing resource to the central data center of the emergency supervision central platform. More descriptions regarding the resource occupancy condition may be found in operation 230 and related descriptions thereof.

The reference computing resource refers to a computing resource required for the sub-data center to process the emergency management data of different modalities in the first target dataset. In some embodiments, the emergency supervision central platform may determine an average value of computing resources required by the sub-data center for processing the emergency management data of different modalities a plurality of times in historical data, and designate the average value as the reference computing resource

The second target dataset refers to a collection of a plurality of emergency management data to be processed in a specific order. In some embodiments, the second target dataset includes a plurality of emergency management data to be sorted.

In some embodiments, for each of the plurality of sub-data centers, in response to determining that the remaining computing resource of the sub-data center is less than the reference computing resource, the emergency supervision central platform may directly determine the first target dataset as the second target dataset.

In some embodiments, the emergency supervision central platform may further obtain a priority dataset from the first target dataset, and determine the second target dataset based on the priority dataset, the first target dataset, the remaining computing resource, and the reference computing resource.

The priority dataset refers to a collection of emergency management data that that needs to be processed with priority. In some embodiments, the priority dataset includes emergency management data with a risk level higher than a preset risk threshold. For example, the priority dataset may include emergency management data corresponding to incidents such as fires at gas stations or chemical storage facilities. In some embodiments, the risk level of each emergency management data may be set by technical personnel within the electronic tag associated with the emergency management data. The preset risk threshold may be set by technical personnel based on experience.

In some embodiments, the emergency supervision central platform may screen emergency management data whose risk levels are higher than the preset risk threshold from the first target dataset, and combine the emergency management data to obtain the priority dataset.

In some embodiments, in response determining that the remaining computing resource is less than the reference computing resource, the emergency supervision central platform may remove the priority dataset from the first target dataset and combine the remaining emergency management data to obtain the second target dataset. The emergency supervision central platform may generate a processing instruction for the priority dataset and the second target dataset, and issue the processing instruction to a corresponding sub-data center. The corresponding sub-data center may first process the emergency management data in the priority dataset, and then process the emergency management data in the second target dataset

It may be understood that the emergency management data with relatively high risk level requires immediate processing. In some embodiments of the present disclosure, by screening the emergency management data whose risk levels are higher than the preset risk threshold from the first target dataset to obtain the priority dataset and combining the remaining emergency management data to obtain the second target dataset, a foundation is laid for subsequently determining a more rational data processing sequence, thereby improving the response speed of emergency management.

The target processing order refers to an order in which all emergency management data in the second target dataset is to be processed. In some embodiments, priority levels of emergency management data of different modalities may be preset by technical personnel. In response to determining that the remaining computing resource of the sub-data center is less than the reference computing resource, the emergency supervision central platform may sort all emergency management data in the second target dataset in descending order (from a highest priority level to a lowest priority level) based on preset priority levels of the emergency management data of different modalities to obtain the target processing order. The preset priority level of each emergency management data may be set in the electronic tag corresponding to the emergency management data.

In 220, a pending data volume may be predicted based on first historical data.

The first historical data refers to a plurality of pending data of different modalities at a plurality of time points within the preset cycle in historical data. In some embodiments, the emergency supervision central platform may obtain the first historical data from the sub-data center.

The pending data refers to emergency management data of different modalities that the sub-data center needs to process at a plurality of time points within a next preset cycle. In some embodiments, each pending data includes a pending data volume and a time point corresponding to the pending data.

The pending data volume refers to an amount of computing resources required to process the pending data. In some embodiments, for each modality, the emergency supervision central platform may obtain a prediction curve by fitting the first historical data, and determine pending data volumes at a plurality of time points within the next preset cycle for the modality based on the prediction curve. The prediction curve refers to a curve representing how the volume of the pending data of a modality changes over time at a plurality of time points within the preset cycle. In some embodiments, the fitting manners include, but are not limited to, a linear regression model, a polynomial regression model, or the like.

In some embodiments, for each of the plurality of sub-data centers, based on the first historical data, second historical data, and a regional feature, the pending data volume of the sub-data center may be predicted through a data volume prediction model.

The second historical data refers to pending data of a plurality of modalities that require processing at a plurality of time points within a previous preset cycle in the historical data. In some embodiments, the emergency supervision central platform may obtain the second historical data from the sub-data center. The previous preset cycle refers to a preceding period relative to a current preset cycle.

The regional feature refers to a feature associated with a geographical region to which an emergency supervision sub-platform corresponding to the sub-data center belongs. For example, the regional feature may include a geographical feature, a pedestrian flow, an industrial type, or the like. The geographical feature may include whether the geographical region is geologically active. The industrial type may include heavy industry, light industry, etc. The regional feature may be preset by technical personnel.

The data volume prediction model refers to a model configured to predict the pending data volume. In some embodiments, the data volume prediction model is a machine learning model. For example, the data volume prediction model may be a neural network (NN) model, a user-defined model, or the like, or any combination thereof.

In some embodiments, an input of the data volume prediction model may include the first historical data, the second historical data, and the regional feature. An output of the data volume prediction model may include the pending data volume of the sub-data center.

In some embodiments, the data volume prediction model may be obtained by training based on a plurality of first training samples with first training labels. For example, the emergency supervision central platform may input the first training samples into an initial data volume prediction model, construct a loss function based on the output of the initial data volume prediction model and the first labels, and iteratively update parameters of the initial data volume prediction model based on the loss function. Iterations may be completed when an iterative condition is satisfied, and a trained data volume prediction model may be obtained. Iterative update manners include, but are not limited to, gradient descent. The iterative condition may be that the loss function converges, a count of iterations reaches a threshold, or the like.

In some embodiments, the first training sample may include sample first historical data within a first historical preset cycle, sample second historical data within a second historical preset cycle, and a sample regional feature. The first label of a first training sample may include an actual pending data volume corresponding to the first training sample. The first labels and the first training samples may be obtained based on the historical data. The second historical preset cycle refers to a preceding period relative to the first historical preset cycle.

In some embodiments of the present disclosure, the trained data volume prediction model is used to predict the pending data volume, which can effectively ensure the accuracy of the output results of the model, thereby obtaining a relatively precise prediction of the pending data volume.

In some embodiments, the input of the data volume prediction model further includes a disaster development trend corresponding to the target processing order.

The disaster development trend refers to a changing trajectory of a disaster over a future period. For example, the disaster development trend may include a probability of a disaster occurring within a future period, an impact range of the disaster, an estimated loss that may be caused by the disaster, etc. In some embodiments, when emergency management data is processed according to different target processing orders, different disasters may occur within the future period, with different disaster development trends. Thus, different target processing orders may correspond to different disaster development trends.

In some embodiments, the disaster development trend may be characterized by at least one of the following metrics: a probability of a disaster occurring within a future period, an impact range of the disaster, and an estimated loss that may be caused by the disaster. For example, the disaster development trend may be characterized by the estimated loss that may be caused by the disaster.

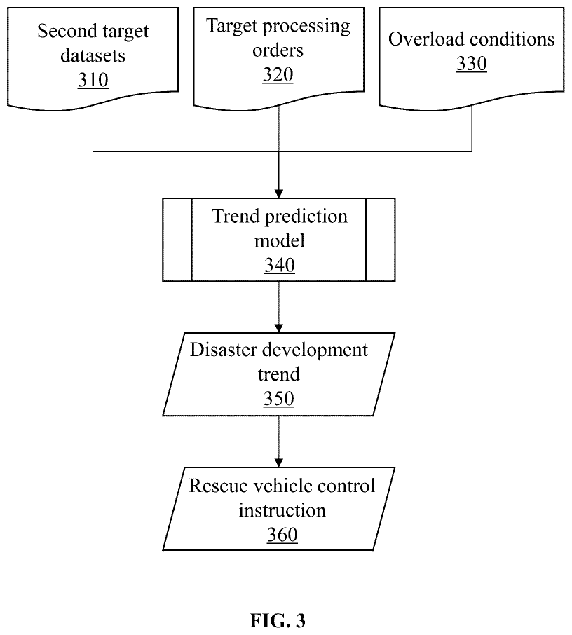

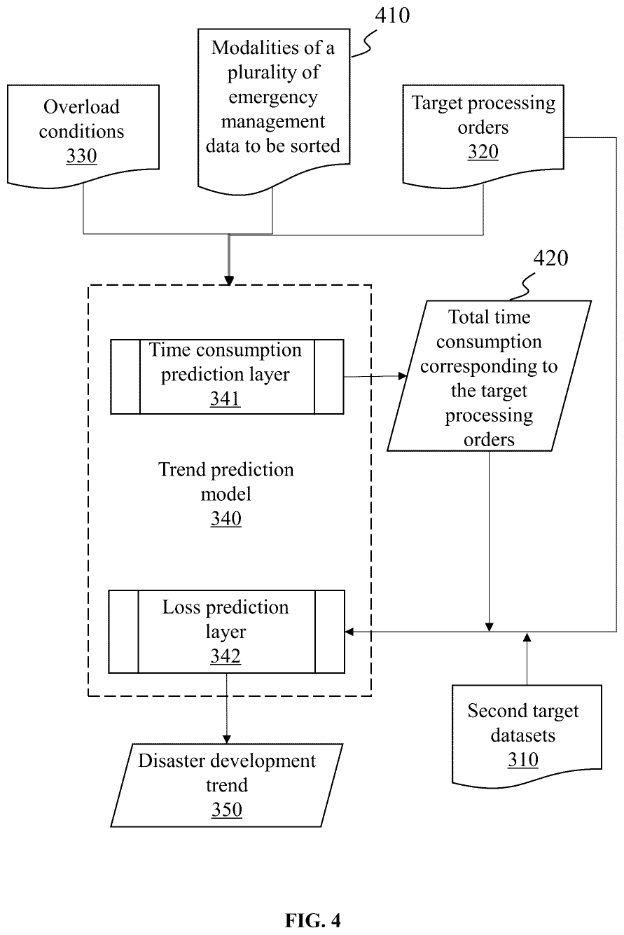

More descriptions regarding the disaster development trend may be found in FIGS. 3-4 and related descriptions thereof.

In some embodiments, when the input of the data volume prediction model includes the disaster development trend corresponding to the target processing order, the first training sample further includes the disaster development trend corresponding to a sample target processing order within the first historical preset cycle. The emergency supervision central platform may determine the disaster development trend corresponding to the sample target processing order within the first historical preset cycle based on an actual disaster condition occurring within the preset time period after the first historical preset cycle.

It may be understood that disasters of different severity levels may affect the frequency of emergency management data collection, thereby influencing the pending data volume within the next preset cycle. In some embodiments of the present disclosure, by incorporating the disaster development trend corresponding to the target processing order as the input to the data volume prediction model, the impact of the disaster development trend on the pending data volume is further considered, thereby further improving the predictive accuracy of the data volume prediction model and resulting in a more accurate predicted pending data volume.

In 230, based on the reference computing resource and the pending data volume, a resource occupancy condition may be predicted, and an overload condition may be generated.

The resource occupancy condition refers to an occupancy condition of the computing resources of the sub-data center at the plurality of time points within the next preset cycle. The resource occupancy condition may be represented as a ratio (also referred to as a resource occupancy ratio) of the computing resources occupied by the sub-data center for processing the plurality of pending data of different modalities at the plurality of time points within the next preset cycle to total computing resources of the sub-data center. The computing resources occupied by the sub-data center for processing the plurality of pending data of different modalities at the plurality of time points within the next preset cycle are also referred to as the occupied computing resources.

In some embodiments, for each of the plurality of sub-data centers, the emergency supervision central platform may determine the occupied computing resources based on the pending data volume and the reference computing resource, and further determine the ratio of the occupied computing resources to the total computing resources of the sub-data center, thereby obtaining the resource occupancy condition of the sub-data center at the plurality of time points within the next preset cycle.

The overload condition refers to a condition in which the occupied computing resources exceed the total computing resources of the sub-data center. In some embodiments, the overload condition includes one or more overload time points and an overload amount corresponding to each of the one or more overload time points.

The overload time point(s) refer to time point(s) at which the occupied computing resources exceed the total computing resources of the sub-data center. In some embodiments, for each of the plurality of sub-data centers, the emergency supervision central platform may determine one or more time points corresponding to a resource occupancy ratio greater than 100% as the overload time point(s) of the sub-data center within the next preset cycle, based on the resource occupancy condition of the sub-data center at the plurality of time points within the next preset cycle.

The overload amount refers to an amount by which the occupied computing resources exceed the total computing resources of the sub-data center. In some embodiments, the emergency supervision central platform may determine a difference between the occupied computing resources corresponding to an overload time point and the total computing resources of the sub-data center as the overload amount corresponding to the overload time point.

In 240, a data transmission order may be determined based on the target processing orders of the plurality of sub-data centers, and the second target dataset may be transmitted based on the data transmission order.

The data transmission order refers to an order in which all emergency management data in the second target dataset is transmitted. In some embodiments, for each of the plurality of sub-data centers, the emergency supervision central platform may determine the target processing order of the sub-data center as the data transmission order of the sub-data center based on the target processing orders of the plurality of sub-data centers, and cause the sub-data center to transmit the second target dataset according to the data transmission order.

In some embodiments of the present disclosure, by determining the target processing order based on the priority levels of the emergency management data, and transmitting and processing the emergency management data according to the data transmission order and the target processing order, more important emergency management data can be prioritized for processing, thereby improving data processing efficiency and reducing data processing time.

In some embodiments, based on the overload conditions and the pending data volumes of the plurality of sub-data centers, the emergency supervision central platform may generate a resource control instruction, and send the resource control instruction to the plurality of sub-data centers to control each of the plurality of sub-data centers to clear a cache space and/or adjust a transmission bandwidth.

The resource control instruction refers to an instruction generated based on a current resource usage and a performance indicator of the emergency management system, used to guide the plurality of sub-data centers to perform resource cleanup and optimization operations. In some embodiments, the emergency supervision central platform may determine a resource control parameter based on the overload conditions and the pending data volumes of the plurality of sub-data centers, and automatically generate the resource control instruction based on the resource control parameter via a preset program. The preset program may be preset by technical personnel.

The resource control parameter refers to one or more parameters for dynamically managing and allocating resources of the sub-data center. In some embodiments, the resource control parameter may include, for the plurality of time points within the next preset cycle, a cache size to be cleared for each of the plurality of sub-data centers and/or the transmission bandwidth allocated to each of the plurality of sub-data centers.

In some embodiments, for each overload time point, the emergency supervision central platform may determine the cache size to be cleared for each of the plurality of sub-data centers based on the overload amount, such that the remaining computing resource of the sub-data center is not less than the reference computing resource. The cache size to be cleared is not less than the overload amount. More descriptions regarding the remaining computing resource and the reference computing resource may be found in operation 210 and related descriptions thereof.

In some embodiments, for each of the plurality of sub-data centers, the emergency supervision central platform may adjust the transmission bandwidth for the sub-data center at the plurality of time points within the next preset cycle, such that the transmission bandwidth of the sub-data center at each of the plurality of time points is not less than the corresponding pending data volume.

The transmission bandwidth describes an amount of data that a data transmission channel (e.g., a network link, a communication line, etc.) may transmit per unit of time. In some embodiments, based on the resource control parameter, the emergency supervision central platform may adjust the transmission bandwidth of each of the plurality of sub-data centers at the plurality of time points within the next preset cycle based on the transmission bandwidth allocated to the sub-data center.

It should be noted that the emergency supervision central platform may, based on actual conditions, control the plurality of sub-data centers to clear the cache space or adjust the transmission bandwidth, or simultaneously control the plurality of sub-data centers to clear the cache space and adjust the transmission bandwidth.

In some embodiments of the present disclosure, generating the resource control parameter based on accurate predictions of the overload time point(s) and multimodal data volumes enables proactive clearing of redundant cache and allocation of transmission bandwidth before the next preset cycle, thereby effectively preventing system crashes caused by sudden data congestion.

In some embodiments, based on the second target datasets, the target processing orders, and the overload conditions of the plurality of sub-data centers, the emergency supervision central platform may generate at least one of a valve control instruction, a power vehicle control instruction, and a rescue vehicle control instruction, and send the at least one instruction to the emergency supervision object platform to control a smart gas valve to automatically open or close based on an open-close state, control a mobile emergency power vehicle to travel based on a driving route and supply power based on a power output, and/or control a display terminal disposed on a rescue vehicle to display a rescue route based on a rescue arrival deadline.

The valve control instruction is configured to control the smart gas valve to automatically open or close. The power vehicle control instruction is configured to control the mobile emergency power vehicle to travel to a corresponding geographical region based on the driving route and to supply power based on the power output. The rescue vehicle control instruction is configured to control the display terminal disposed on the rescue vehicle to display the rescue route based on the rescue arrival deadline. The display terminal is a display device for interaction between the rescue vehicle and rescue personnel. For example, the display terminal may include an in-vehicle display screen, or the like.

In some embodiments, the emergency supervision central platform may determine an emergency management parameter based on the second target datasets, the target processing orders, and the overload conditions of the plurality of sub-data centers, and then automatically generate at least one of the valve control instruction, the power vehicle control instruction, and the rescue vehicle control instruction based on the emergency management parameter via a preset program. The preset program may be preset by technical personnel.

The emergency management parameter refers to one or more parameters related to emergency management. In some embodiments, the emergency management parameters may include the open-close state of the smart gas valve, the driving route, the power output of the mobile emergency power vehicle, the rescue arrival deadline, and the rescue route of the rescue vehicle. The rescue vehicle may include a gas emergency repair vehicle, a fire truck, an ambulance, a search and rescue vehicle, or the like. The rescue arrival deadline refers to a latest time for the rescue vehicle to arrive at a geographical region to which each emergency management data belongs. The rescue route refers to a route for the rescue vehicle to travel to the geographical region to which each emergency management data belongs.

The emergency supervision central platform may determine the emergency management parameters in a plurality of manners based on the second target datasets, the target processing orders, the overload time points, and the overload amounts of the plurality of sub-data centers within the next preset cycle. More descriptions regarding the overload time point and the overload amount may be found in operation 230 and related descriptions thereof.

In some embodiments, based on the second target datasets of the plurality of sub-data centers, for emergency management data in the second target dataset whose processing time exceeds a first preset threshold, the emergency supervision central platform may determine the open-close state of the smart gas valve, the driving route, and the power output of the mobile emergency power vehicle corresponding to the aforementioned emergency management data by querying a first preset table.

The processing time of a piece of emergency management data refers to a time period required to process the piece of emergency management data. In some embodiments, the emergency supervision central platform may determine a time point at which a piece of emergency management data is processed and a time point at which a next piece of emergency management data is processed based on a target processing order, and obtain the processing time by determining a difference between the two time points.

The first preset table may reflect a relationship between the emergency management data, the difference between the processing time and the first preset threshold, the open-close state of the smart gas valve, the driving route, and the power output of the mobile emergency power vehicle. In some embodiments, the first preset table may be constructed by technical personnel based on experience. The first preset threshold may be determined by technical personnel based on experience.

In some embodiments, the emergency supervision central platform may further determine the rescue arrival deadline and the rescue route of the rescue vehicle corresponding to each piece of emergency management data in the second target dataset by querying a second preset table, based on the second target datasets, the overload time points, and the overload amounts of the plurality of sub-data centers within the next preset cycle.

The second preset table may reflect a relationship between the emergency management data, the count of overload time points, an average value of the overload amounts corresponding to overload time points, the rescue arrival deadline, and the rescue route of the rescue vehicle. In some embodiments, the second preset table may be constructed by technical personnel based on experience.

More descriptions regarding generating the rescue vehicle control instruction may be found in FIG. 3 and related descriptions thereof.

In some embodiments, in response to receiving at least one of the valve control instruction, the power vehicle control instruction, and the rescue vehicle control instruction sent by the emergency supervision central platform, the emergency supervision object platform may control the smart gas valve to automatically open or close based on the open-close state, control the mobile emergency power vehicle to travel based on the driving route and supply power based on the power output, and/or control the display terminal disposed on the rescue vehicle to display the rescue route based on the rescue arrival deadline.

In some embodiments, in response to receiving the valve control instruction, the emergency supervision object platform may automatically generate a control signal and send the control signal to the smart gas valve to control the smart gas valve to automatically open or close based on the open-close state. For example, in response to receiving the valve control instruction, when the open-close state of the smart gas valve is closed, the emergency supervision object platform may control the smart gas valve to automatically open.

In some embodiments, in response to receiving the power vehicle control instruction, the emergency supervision object platform may automatically generate a control signal and send the control signal to the mobile emergency power vehicle to control the mobile emergency power vehicle to travel to a corresponding geographical region based on the driving route and supply power based on the power output. For example, when a disaster causes a power outage, the mobile emergency power vehicle may supply power to an affected geographical region.

In some embodiments, in response to receiving the rescue vehicle control instruction, the emergency supervision object platform may automatically generate a control signal and send the control signal to the display terminal to control the display terminal to automatically display the rescue route based on the rescue arrival deadline.

More descriptions regarding how the emergency supervision object platform controls the display terminal to automatically display the rescue route may be found later in the present disclosure.

It should be understood that when a sub-data center is overloaded, implementing preventive emergency management measures in a timely manner based on the emergency management parameter not only improve the responsiveness of the emergency management system to various emergencies but also effectively avoid greater losses caused by untimely data processing.

In some embodiments, during a process in which the rescue vehicle travels based on the rescue route, the rescue vehicle is configured to determine a risk region based on road condition data and transmit the risk region to the emergency supervision management platform.

The road condition data refers to data related to a road on which the rescue vehicle travels. For example, the road condition data may include a type of a hazardous gas at an incident scene along the road, a concentration of the hazardous gas, a thermal image of the incident scene, a color image of the incident scene, or the like. In some embodiments, the road condition data may be obtained through a sensing device (e.g., a gas sensor, a thermal imager, a camera, etc.) disposed on the rescue vehicle.

In some embodiments, a terminal (e.g., an onboard information terminal, an onboard computer, etc.) disposed on the rescue vehicle may determine risks on the rescue route by querying a third preset table based on the road condition data, and determine a region with risks as the risk region.

The third preset table may reflect a relationship between the road condition data, a risk type, and a risk level. The risk type includes, but is not limited to, a crowd gathering, a building collapse, smoke diffusion, or the like. The risk level indicates a severity level of the risk. When the risk level is greater than 0, it indicates that a risk exists. In some embodiments, the third preset table may be constructed based on historical data.

In some embodiments, a scope of the risk region is positively correlated with the risk level. The higher the risk level, the larger the scope of the risk region. The scope of the risk region refers to an impact or affected range of the risk. The scope of the risk region may be determined by using an acquisition location of the road condition data as a reference point. Risk regions of different risk types may be represented by different colors.

In some embodiments of the present disclosure, by obtaining the road condition data during the rescue vehicle's travel along the rescue route to identify the risk region and transmitting the risk region back to the emergency supervision management platform, the emergency supervision management platform can gain a more precise understanding of the actual risk situation, thereby facilitating targeted and timely rescue efforts.

It should be noted that the foregoing descriptions of process 200 are intended to be exemplary and illustrative only and do not limit the scope of application of the present disclosure. For those of ordinary skill in the art, various corrections and changes may be made to process 200 under the guidance of the present disclosure. However, these corrections and changes remain within the scope of the present disclosure.

FIG. 3 is a flowchart illustrating an exemplary process for generating a rescue vehicle control instruction according to some embodiments of the present disclosure.

In some embodiments, a rescue vehicle control instruction includes a rescue vehicle type and a rescue vehicle count. In some embodiments, as shown in FIG. 3, based on second target datasets 310, target processing orders 320, and overload conditions 330 of a plurality of sub-data centers, the emergency supervision management platform 130 (e.g., the emergency supervision central platform 131) may determine a disaster development trend 350 corresponding to each of the target processing orders through a trend prediction model 340, and generate a rescue vehicle control instruction 360 based on the disaster development trends 350 corresponding to the target processing orders of the plurality of sub-data centers.

More descriptions regarding the second target dataset, the target processing order, the overload condition, the disaster development trend, and the rescue vehicle control instruction may be found in FIG. 2 and related descriptions thereof.

The trend prediction model is configured to predict the disaster development trend corresponding to each target processing order. In some embodiments, the trend prediction model is a machine learning model. For example, the trend prediction model may be a deep neural network (DNN) model, a user-defined model, or the like, or any combination thereof.

FIG. 4 is a schematic diagram illustrating an exemplary trend prediction model according to some embodiments of the present disclosure. As shown in FIG. 4, the trend prediction model 340 includes a time consumption prediction layer 341 and a loss prediction layer 342.

The time consumption prediction layer is configured to determine a total time consumption corresponding to the target processing orders of a plurality of sub-data platforms. In some embodiments, the time consumption prediction layer is a machine learning model. For example, the time consumption prediction layer may be a DNN model.

In some embodiments, as shown in FIG. 4, an input of the time consumption prediction layer 341 includes target processing orders 320 and overload conditions 330 of a plurality of sub-data platforms, and modalities 410 of a plurality of emergency management data to be sorted; an output of the time consumption prediction layer 341 includes a total time consumption 420 corresponding to the target processing orders 320. More descriptions regarding the emergency management data and the modality may be found in FIG. 2 and related descriptions thereof.

In some embodiments, the time consumption prediction layer may be obtained by training based on a plurality of second training samples with second training labels. A training process of the time consumption prediction layer is similar to that of the data volume prediction model. More descriptions regarding the training process may be found in operation 220 in FIG. 2.

In some embodiments, the second training samples include sample processing orders from historical processing procedures, modalities of sample emergency management data in sample second target datasets, and sample overload conditions. The second labels include actual total time consumption for processing the sample second target datasets according to the sample processing orders in the historical processing procedures. The second training samples and the second labels may be obtained based on historical data.

The loss prediction layer 342 is configured to predict a disaster development trend corresponding to the target processing order. In some embodiments, the loss prediction layer 342 is a machine learning model. For example, the loss prediction model may include a DNN model, or the like.

In some embodiments, as shown in FIG. 4, an input of the loss prediction layer 342 includes second target dataset 310 of the plurality of sub-data platforms, the target processing order 320 corresponding to the second target datasets 310, and the total time consumption 420 corresponding to the target processing orders; an output of the loss prediction layer 342 includes the disaster development trend 350 corresponding to the target processing orders.

In some embodiments, the loss prediction layer may be obtained by training based on a plurality of third training samples with third training labels. A training process of the loss prediction layer is similar to that of the data volume prediction model. More descriptions regarding the training process may be found in operation 220 in FIG. 2.

In some embodiments, the third training samples include sample second target datasets from historical processing procedures, sample processing orders, and a total time consumption corresponding to the sample processing orders. The third labels includes actual disaster(s) occurring after processing the sample second target datasets according to the sample processing orders in the historical processing procedures, an average of actual impact ranges of the disaster(s), and an average value of actual losses caused by the disaster(s). The third training samples and the third labels may be obtained based on historical data.

In some embodiments, the emergency supervision central platform may determine the rescue vehicle type and the rescue vehicle count by querying a fourth preset table based on the disaster development trend. The fourth preset table may reflect a relationship between potential disasters and disaster development trends, and rescue vehicle types and rescue vehicle counts. The fourth preset table may be constructed by technical personnel based on experience.

In some embodiments, the emergency supervision central platform may automatically generate a rescue vehicle control instruction via a preset program based on the rescue vehicle type and the rescue vehicle count, and send the rescue vehicle control instruction to the emergency supervision object platform to control display terminal(s) disposed on corresponding types and counts of rescue vehicles to display rescue route(s) based on the rescue arrival deadline. The preset program may be preset by technical personnel.

In some embodiments of the present disclosure, by processing the second target datasets, the target processing orders, and the overload conditions of the plurality of sub-data centers through the trained trend prediction model, the disaster development trend corresponding to each of the target processing orders can be accurately predicted. Based on the disaster development trends, the rescue vehicle type and the rescue vehicle count are determined, and the rescue vehicle control instruction is generated to dispatch appropriate types and counts of rescue vehicles for emergency response, thereby ensuring rescue efficiency and minimizing the consumption of manpower and material resources to the greatest extent possible.

One or more embodiments of the present disclosure provide a non-transitory computer-readable storage medium that stores computer instructions. When a computer reads the computer instructions from the storage medium, the computer executes the method for multimodal emergency management of a smart city based on the large model of IoT described in one or more embodiments of the present disclosure.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure, or characteristic described in connection with the embodiment is included in at least one embodiment of the present disclosure. Therefore, it is emphasized and should be appreciated that two or more references to “an embodiment” or “one embodiment” or “an alternative embodiment” in various portions of this disclosure are not necessarily all referring to the same embodiment. Furthermore, the particular features, structures, or characteristics may be combined as suitable in one or more embodiments of the present disclosure.

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software only solution, e.g., an installation on an existing server or mobile device.

Similarly, it should be noted that in the foregoing description of embodiments of the present disclosure, various features are sometimes grouped together in a single embodiment, figure, or description thereof for the purpose of streamlining the disclosure aiding in the understanding of one or more of the various inventive embodiments. This method of disclosure, however, is not to be interpreted as reflecting an intention that the claimed subject matter requires more features than are expressly recited in each claim. Rather, inventive embodiments lie in less than all features of a single foregoing disclosed embodiment.

Each of the patents, patent applications, publications of patent applications, and other material, such as articles, books, specifications, publications, documents, things, and/or the like, referenced herein is hereby incorporated herein by this reference in its entirety for all purposes, excepting any prosecution file history associated with same, any of same that is inconsistent with or in conflict with the present document, or any of same that may have a limiting effect as to the broadest scope of the claims now or later associated with the present document. By way of example, should there be any inconsistency or conflict between the description, definition, and/or the use of a term associated with any of the incorporated material and that associated with the present document, the description, definition, and/or the use of the term in the present document shall prevail.

In closing, it is to be understood that the embodiments of the application disclosed herein are illustrative of the principles of the embodiments of the application. Other modifications that may be employed may be within the scope of the application. Thus, by way of example, but not of limitation, alternative configurations of the embodiments of the application may be utilized in accordance with the teachings herein. Accordingly, embodiments of the present application are not limited to that precisely as shown and described.

What is claimed is:

1. A system for multimodal emergency management of a smart city based on a large model of Internet of Things (IoT), comprising: an emergency supervision management platform, an emergency supervision sensor network platform, and an emergency supervision object platform; wherein
the emergency supervision management platform includes an emergency supervision central platform, a plurality of emergency supervision sub-platforms, and a plurality of sub-data centers;
the emergency supervision management platform is configured to:
based on a preset cycle, for each of the plurality of sub-data centers,
determine a second target dataset and a target processing order based on a remaining computing resource, a reference computing resource, and a first target dataset;
predict a pending data volume based on first historical data;
based on the reference computing resource and the pending data volume, predict a resource occupancy condition, and generate an overload condition; and
determine a data transmission order for each of the plurality of sub-data centers based on target processing orders of the plurality of sub-data centers, and transmit the second target dataset of each of the plurality of sub-data centers based on the data transmission order of the sub-data center.

2. The system of claim 1, wherein the emergency supervision management platform is further configured to:
based on the overload conditions and the pending data volumes of the plurality of sub-data centers, generate a resource control instruction, and send the resource control instruction to the plurality of sub-data centers to control each of the plurality of sub-data centers to clear a cache space and/or adjust a transmission bandwidth.

3. The system of claim 1, wherein the emergency supervision management platform is further configured to:
based on the second target datasets, the target processing orders, and the overload conditions of the plurality of sub-data centers, generate at least one of a valve control instruction, a power vehicle control instruction, and a rescue vehicle control instruction, and send the at least one instruction to the emergency supervision object platform to control a smart gas valve to automatically open or close based on an open-close state, control a mobile emergency power vehicle to travel based on a driving route and supply power based on a power output, and/or control a display terminal disposed on a rescue vehicle to display a rescue route based on a rescue arrival deadline.

4. The system of claim 3, wherein, during a process in which the rescue vehicle travels based on the rescue route, the rescue vehicle is configured to determine a risk region based on road condition data and transmit the risk region to the emergency supervision management platform.

5. The system of claim 3, wherein the rescue vehicle control instruction includes a rescue vehicle type and a rescue vehicle count;
the emergency supervision management platform is further configured to:
determine, based on the second target datasets, the target processing orders and the overload conditions of the plurality of sub-data centers, a disaster development trend corresponding to each of the target processing orders through a trend prediction model, the trend prediction model being a machine learning model; and
generate the rescue vehicle control instruction based on the disaster development trends corresponding to the target processing orders of the plurality of sub-data centers.

6. The system of claim 1, wherein the emergency supervision management platform is further configured to:
for each of the plurality of sub-data centers, based on the first historical data, second historical data, and a regional feature, predict the pending data volume of the sub-data center through a data volume prediction model, the data volume prediction model being a machine learning model.

7. The system of claim 6, wherein an input of the data volume prediction model further includes the disaster development trend corresponding to the target processing order.

8. A method for multimodal emergency management of a smart city based on a large model of Internet of Things (IoT), executed by an emergency supervision management platform, comprising:
based on a preset cycle, for each of a plurality of sub-data centers,
determining a second target dataset and a target processing order based on a remaining computing resource, a reference computing resource, and a first target dataset;
predicting a pending data volume based on first historical data;
based on the reference computing resource and the pending data volume, predicting a resource occupancy condition, and generating an overload condition; and
determining a data transmission order for each of the plurality of sub-data centers based on target processing orders of the plurality of sub-data centers, and transmitting the second target dataset of each of the plurality of sub-data centers based on the data transmission order of the sub-data center.

9. The method of claim 8, further comprising:
based on the overload conditions and the pending data volumes of the plurality of sub-data centers, generating a resource control instruction, and sending the resource control instruction to the plurality of sub-data centers to control each of the plurality of sub-data centers to clear a cache space and/or adjust a transmission bandwidth.

10. The method of claim 8, further comprising:
based on the second target datasets, the target processing orders, and the overload conditions of the plurality of sub-data centers, generating at least one of a valve control instruction, a power vehicle control instruction, and a rescue vehicle control instruction, and sending the at least one instruction to the emergency supervision object platform to control a smart gas valve to automatically open or close based on an open-close state, control a mobile emergency power vehicle to travel based on a driving route and supply power based on a power output, and/or control a display terminal disposed on a rescue vehicle to display a rescue route based on a rescue arrival deadline.

11. The method of claim 10, wherein, during a process in which the rescue vehicle travels based on the rescue route, the rescue vehicle is configured to determine a risk region based on road condition data and transmit the risk region to the emergency supervision management platform.

12. The method of claim 10, wherein the rescue vehicle control instruction includes a rescue vehicle type and a rescue vehicle count; and the generating at least one of a valve control instruction, a power vehicle control instruction, and a rescue vehicle control instruction based on the second target datasets, the target processing orders, and the overload conditions of the plurality of sub-data centers includes:
determining, based on the second target datasets, the target processing orders and the overload conditions of the plurality of sub-data centers, a disaster development trend corresponding to each of the target processing orders through a trend prediction model, the trend prediction model being a machine learning model; and
generating the rescue vehicle control instruction based on the disaster development trends corresponding to the target processing orders of the plurality of sub-data centers.

13. The method of claim 8, wherein the predicting a pending data volume based on first historical data includes:
for each of the plurality of sub-data centers, based on the first historical data, second historical data, and a regional feature, predicting the pending data volume of the sub-data center through a data volume prediction model, the data volume prediction model being a machine learning model.

14. The method of claim 13, wherein an input of the data volume prediction model further includes the disaster development trend corresponding to the target processing order.

15. A non-transitory computer-readable storage medium, storing computer instructions, wherein when a computer reads the computer instructions from the storage medium, the computer executes a method for multimodal emergency management of a smart city based on a large model of Internet of Things (IoT), executed by an emergency supervision management platform, the method comprising:
based on a preset cycle, for each of a plurality of sub-data centers,
determining a second target dataset and a target processing order based on a remaining computing resource, a reference computing resource, and a first target dataset;
predicting a pending data volume based on first historical data;
based on the reference computing resource and the pending data volume, predicting a resource occupancy condition, and generating an overload condition; and
determining a data transmission order for each of the plurality of sub-data centers based on target processing orders of the plurality of sub-data centers, and transmitting the second target dataset of each of the plurality of sub-data centers based on the data transmission order of the sub-data center.
